(19) United States
(12) Patent Application Publication
(10) Pub. No.: US 2014/0148177 A1
(43) Pub. Date: May 29, 2014

(54) Method for Network-Coordinated Device-to-Device Communication

(71) Applicant: NOKIA SIEMENS NETWORKS OY, Espoo (FI)

(72) Inventors: Rapeepat RATASUK, Hoffman Estates, IL (US); Amitabha GHOSH, Buffalo Grove, IL (US)

(73) Assignee: NOKIA SIEMENS NETWORKS OY, Espoo (FI)

(21) Appl. No.: 13/687,711

(22) Filed: Nov. 28, 2012

(51) Int. Cl. H04W 72/04; H04W 4/00

(52) U.S. Cl. CPC H04W 72/04; H04W 4/005
USPC 455/450

(57) ABSTRACT

Various communication systems may benefit from network coordination. For example, a system of the long term evolution (LTE) of the third generation partnership project (3GPP) that utilizes device-to-device communication may benefit from various methods, devices, and systems for network-coordinated device-to-device communication. For example, a method may include determining a penalty for using a subframe for device-to-device communication based on radio conditions. The method may also include applying the penalty in selecting radio resources for a user equipment for device-to-device communication.

### BACKGROUND

1. Field

Various communication systems may benefit from network coordination. For example, a system of the long term evolution (LTE) of the third generation partnership project (3GPP) that utilizes device-to-device communication may benefit from various methods, devices, and systems for network-coordinated device-to-device communication.

2. Description of the Related Art

Device-to-device (D2D) communication, which can also be referred to as peer-to-peer communication, may provide various features, such as reduced latency, increased total cell throughput, support of new services such as direct advertisement, and offloading of traffic to unlicensed spectrum. For example, in D2D communications, the packet may not have to go through the network. Thus, D2D communications may provide improved throughput for devices that are in close proximity of each other and may offload traffic from a base station, such as an evolved Node B (eNB). Thus, the cell may have higher total cell throughput. D2D communication may be utilized, for example, in machine-to-machine (M2M) communication and other similar approaches.

D2D communication may be done using in-band or out-of-band frequency resources. Out of band frequency resource may be, for example, from unlicensed, lightly-licensed, or secondary usage bands. By contrast, in-band frequency resources may be the resources used by the devices for communication with a base station or access point.

FIG. 1 illustrates device-to-device communication. In this case, UE1 may wish to communicate with UE2. Rather than going through the network, UE1 and UE2 can establish direct communication by forming a D2D pair and bypassing the network. The establishment of D2D pair may be done through the aid of the network, or independently using any of various discovery methods. Once the pairing is established, communication between the devices can begin. This communication can be done independently of the network, but the communication can create large amount of interference to nearby UEs, such as UE4.

### SUMMARY

According to certain embodiments, a method includes determining a penalty for using a subframe for device-to-device communication based on radio conditions. The method also includes applying the penalty in selecting radio resources for a user equipment for device-to-device communication.

In certain embodiments, an apparatus includes at least one processor and at least one memory including computer program code. The at least one memory and the computer program code are configured to, with the at least one processor, cause the apparatus at least to determine a penalty for using a subframe for device-to-device communication based on radio conditions. The at least one memory and the computer program code are also configured to, with the at least one processor, cause the apparatus at least to apply the penalty in selecting radio resources for a user equipment for device-to-device communication.

A non-transitory computer-readable medium is, in certain embodiments, encoded with instructions that, when executed in hardware, perform a process. The process includes determining a penalty for using a subframe for device-to-device communication based on radio conditions. The process also includes applying the penalty in selecting radio resources for a user equipment for device-to-device communication.

### BRIEF DESCRIPTION OF THE DRAWINGS

For proper understanding of the invention, reference should be made to the accompanying drawings, wherein:

FIG. 1 illustrates device-to-device communication.

FIG. 2 illustrates examples of D2D regions, according to certain embodiments.

FIG. 3 illustrates D2D transmission in DL subframes, according to certain embodiments.

FIG. 4 illustrates a method according to certain embodiments.

FIG. 5 illustrates an apparatus according to certain embodiments.

FIG. 6 illustrates interference management according to certain embodiments.

FIG. 7 illustrates gain based on IoT reduction according to certain embodiments.

### DETAILED DESCRIPTION

Device-to-device (D2D) communications may provide various benefits, such as reduced latency, increased total cell throughput, support of new services such as direct advertisement, and offloading of traffic to unlicensed spectrum.

With in-band D2D communication, the devices can share the same spectrum as the primary network, such as, for example, a regular long term evolution (LTE) communication, which may be the communication between eNode B (eNB) and user equipment (UE). In this case, the eNB may take care to ensure that D2D and communication between eNB and UE do not create substantial interference with one another.

Multiple approaches to mitigating interference can be used. According to a first approach, the network can reserve frequency resources for D2D communication. According to a second approach, D2D communication can be scheduled by the eNB.

In the first approach, the resource can be dedicated to D2D or shared with communication between eNB and UE. Two or more devices that are communicating device-to-device amongst one another can be considered a D2D pair, even if more than two devices are involved. D2D pairs may be free to communicate within the reserved resource without further instructions from the network. For instance, the network can reserve two subframes every radio frame for D2D communication and all D2D UEs may be free to transmit in those subframes. If the resource is shared, the network can manage interference by controlling the power of the devices or limiting its own transmission power.

In the second approach, D2D communication may be scheduled by the network. In this case, the eNB can give explicit scheduling assignment for each D2D pair, similar to the UL/DL scheduling grant for normal communication between eNB and UE.

Certain embodiments apply to the first approach, in which the network reserves time-frequency resource for D2D communication but does not perform direct scheduling. For example, certain embodiments provide a method for D2D and eNB-UE coordination such that both types of communication can share the same time and frequency resource, thus, in certain cases, maximizing spectrum usage and user experience.

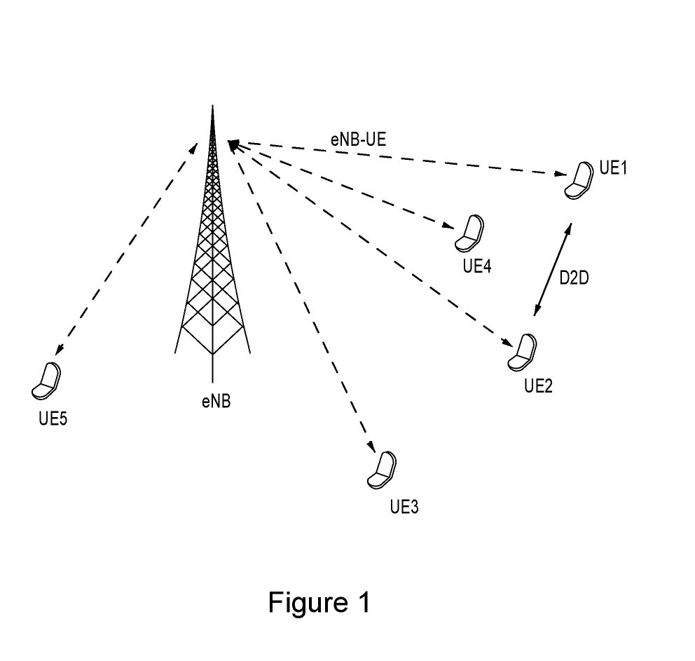

FIG. 1 illustrates device-to-device communication. In this case, UE1 may wish to communicate with UE2. Rather than communicating through the network, UE1 and UE2 can establish direct communication by forming a D2D pair and bypassing the network. The establishment of the D2D pair may be done through the aid of the network, or independently using discovery methods. Once the pairing is established, communication between the devices can begin. This communication can be done independently of the network, but such communication may create interference to nearby UEs, such as UE4. Therefore, network coordination in term of resources to be used for D2D communication and interference management techniques may be needed.

Certain embodiments may provide a network time and frequency resource reservation method for D2D communication. Network time and/or frequency resources can be referred to as a D2D region. Reservation can be done in a semi-static manner and broadcasted to UEs. Within the D2D region, UEs may be free to communicate directly with each other as they wish. In a frequency division duplex (FDD) system, the D2D region may be reserved from either the DL or UL frequency band, or both. In scenarios where the system is more heavily used in the downlink direction, it may be beneficial to first reserve resource in the UL frequency band for D2D communication, followed by resources in the DL frequency band as needed.

Moreover, certain embodiments provide interference management methods when DL subframes are used as part of a D2D region. Furthermore, certain embodiments may provide interference management methods when UL subframes are used as part of a D2D region.

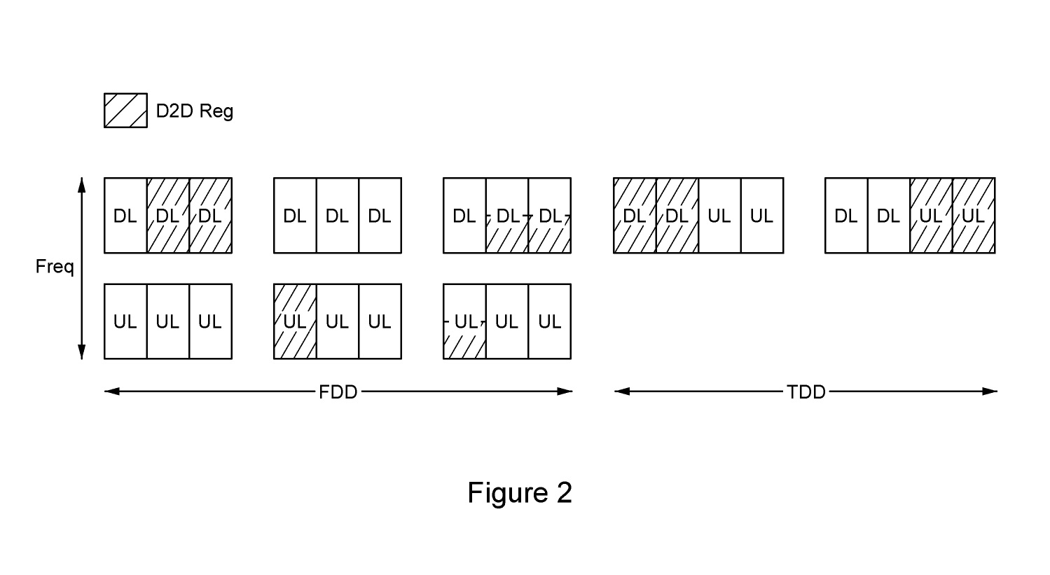

FIG. 2 illustrates examples of D2D regions, according to certain embodiments. A D2D region can be configured in either DL or UL subframes, and can span the entire bandwidth or just a portion of the bandwidth. Note that both frequency division duplex (FDD) and time division duplex (TDD) modes can be supported. TDD mode does not require separate Tx/Rx radio frequency (RF) hardware.

The labeling in FIG. 2 is for communication between eNB and UE, where DL is eNB to UE and UL is UE to eNB. If a DL subframe is used for D2D communication, one D2D UE may transmit while another receives in this DL subframe. This may require changes in UE hardware. For example, FDD UE may need to be able to transmit on the DL frequency, whereas TDD UE may need to be able to transmit on the DL subframe. In addition, while a UE may transmit using single carrier frequency division multiple access (SC-FDMA) it is also possible that a UE may use orthogonal frequency division multiple access (OFDMA), so that a SC-FDMA receive module is not required in the receiver.

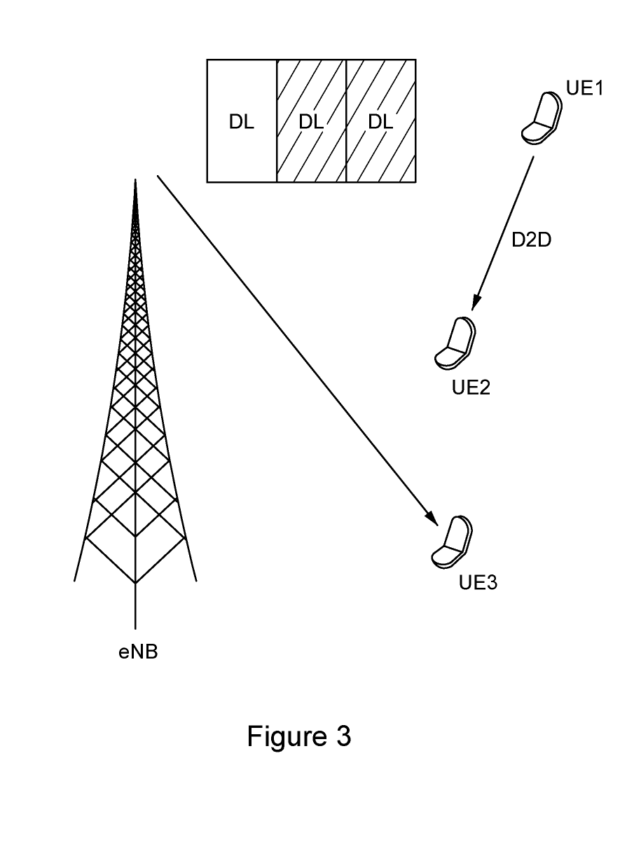

FIG. 3 illustrates an example where downlink subframes are used for D2D. In this case, it can be seen that UE1 will transmit at the same time as the eNB and the transmission from UE1 can generate a lot of interference to UE3's reception. Hence, some kind of interference management technique may be needed.

FIG. 3 illustrates D2D transmission in DL subframes, according to certain embodiments. As discussed below, there may be various methods to determine the D2D region and 3GPP-specific signaling to support such D2D region. Moreover, certain embodiments may provide methods for interference management between D2D and eNB-UE within a D2D region. Further, using beamforming techniques between a pair of D2D devices may further reduce the interference.

For example, a network can determine a D2D region. This generally may be implementation specific and several methods can be used, as described below.

A first method may be a time division multiplexing (TDM) pattern. The network may determine which subframes are to be used for D2D. First, the network may determine whether to use the DL or UL subframe based on a penalty function. Then, the network may determine how many subframes to assign to a D2D region.

In a particular example embodiment, the network can determine a penalty function of DL and UL transmission separately based on served throughput, buffer status of pending traffic, expected interference from D2D transmission, resource block (RB) loading, traffic offloading efficiency, and signal to interference plus noise ratio (SINR). The penalty function may be, for example,

$$f ( UL or DL ) = α \text{?} ( \text{?} ) ( {I}_{D 2 D} )$$

$$\text{?} \text{indicates text missing or illegible when filed}$$

where T_{served} is the amount of traffic served by the link, T_{pending} is the amount of pending traffic, RBᵤₜᵢₗ is the RB utilization, and I_{D2D} is the expected interference from D2D transmission. The terms γ and σ are fairness-related parameters, while a is a link-specific scaling parameter. Alternatively, the penalty function may be f(UL or DL)=α(RB [symbol] )^{γ}ΣKₐ log₁(1÷K_{b}SINR). DL or UL for D2D may be selected based on minimizing the penalty function. Furthermore, a fraction of DL or UL subframes, such as 4 out of 20 subframes, may be selected based on RB loading and expected D2D traffic.

In a second method, a D2D region can be set to be the same as an almost blank subframe/low power subframe (ABS/LPS) pre-configured pattern. The network may reuse a predefined ABS/LPS pattern configured for enhanced intercell interference coordination (eICIC) as D2D region. This may allow coordination of a system-wide D2D region where multiple eNBs coordinate their D2D region using an ABS/LPS pattern to assist D2D communication on the cell edge.

A third method may be a frequency division multiplexing (FDM) pattern. The network may determine how many resource blocks can be reserved for D2D. This may depend on the resource block utilization and expected traffic offloading efficiency, such as the number of RBs that would be required to serve D2D if the same traffic were sent through the network. It may also depend on eICIC consideration, such as how many RBs are reserved for eICIC, and expected interference from D2D transmission.

In an example embodiment, the network may determine a penalty function of DL and UL transmission separately based on served throughput or the like, as discussed above. Moreover, the network may select DL or UL for D2D based on minimizing the penalty function and select a fraction of RBs based on RB loading and expected D2D traffic.

Combinations of the above are also possible. For example, a TDM/FDM pattern can be achieved by combining the TDM approach and the FDM approach described above.

Certain embodiments may also or alternatively include signaling of a D2D region to one or more UEs. Details of this method may include a configuration message that defines the D2D time and frequency region. Examples of the contents of such a configuration message can include a time domain pattern similar to an ABS/LPS pattern configuration to indicate which subframes can be used for D2D communication or a frequency domain bitmap to indicate RBs to be used for D2D communication. Alternatively, several time-frequency patterns can be defined and the index can be indicated to the UEs. Moreover, the configuration message may be broadcasted to the UEs using either system information blocks (SIBs) or radio resource control (RRC) configuration messaging.

Further embodiments may relate to interference management methods for D2D region in the DL. For example, the management methods may include scheduling around D2D pairs. For example, the network can compile a list of D2D pairs and other UEs in close proximity to the pairs based on location information. The eNB can avoid scheduling those UEs during a D2D region. This can be done explicitly, for example, by not scheduling those UEs during D2D communication. Alternatively, this can be done implicitly, for example, by introducing a penalty factor into the scheduling metric of each UE based on expected impact from D2D interference. This penalty factor may be considered only in the D2D region. In an example embodiment

$${P}_{f} ( k ) = \text{?} {I}_{D 2 D}^{γ}$$

$$\text{?} \text{indicates text missing or illegible when filed}$$

where tᵢₙₛₜₐₙₜ is the instantaneous achievable throughput of user k (for example, from channel quality indication (CQI) reports), t_{avg} is the average throughput of user k, and I_{D2D} is the expected interference from D2D transmission. The terms α, β, and γ may be fairness-related parameters.

Certain embodiments may involve scheduling gap or reduced power transmission (e.g. using ABS/LPS subframes). The eNB can avoid DL transmission or can reduce its own DL transmission power in order to avoid creating interference to D2D transmission within the D2D region.

Moreover, certain embodiments may involve beam steering. The eNB may have, or be provided with, a list of D2D pairs with potential transmission in the D2D region and the eNB can steer away from those pairs during D2D region. The eNB can rank the pair based on expected interference from the eNB and can select beamforming weights to minimize the expected interference.

Furthermore, certain embodiments may relate to interference management methods for D2D region in the UL. For example, the network can create a scheduling gap. The eNB can avoid scheduling UL transmission in order to avoid creating interference to D2D transmission within the D2D region.

Moreover, the network may employ power control. The eNB can adjust either the power of the D2D UEs or regular UEs based on priority. For instance, if D2D is prioritized the eNB can increase transmission power of D2D UEs. An example embodiment of such priority may be as follows: Pₜₓ=MIN(Pₘₐₓ, Pₘᵢₙ+α×PL−β×IoT_{D2D})+10 log₁₀(N_{RB})) dBm, in which the terms have the same meaning discussed above.

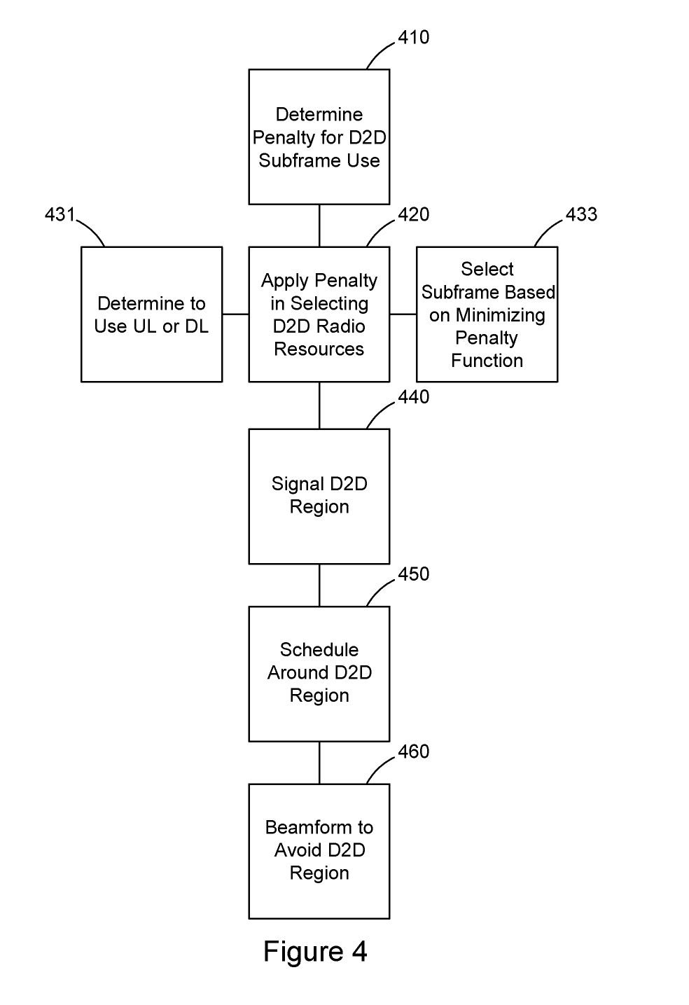

FIG. 4 illustrates a method according to certain embodiments. As shown in FIG. 4, a method can include, at 410, determining a penalty for using a resource, such as a subframe, for device-to-device communication based on performance metrics, such as radio conditions. The term “penalty” may broadly encompass a variety of different kinds of penalties, including, for example, cost, price, utility, and the like. The resource can be a time-frequency resource or a radio resource more generally, with a subframe being one example of such a resource. The performance metrics may include, among other things, radio conditions (as mentioned above), system loading, resource block loading, traffic offloading efficiency, priority, and the like. Thus, the determining the penalty can include determining the penalty based on at least one of served throughput, buffer status, expected interference from device-to-device transmissions, resource block loading, traffic offloading efficiency, or signal to interference plus noise ratio.

The method can also include, at 420, applying the penalty in selecting radio resources for a user equipment for device-to-device communication. The applying the penalty can include, at 431, determining whether to use an uplink subframe or a downlink subframe for device to device communication based on a penalty function. The applying can also include, at 433, the penalty comprises selecting one of a plurality of alternative resources, such as an uplink subframe or a downlink subframe, based on minimizing a penalty function.

The method can further include, at 440, signaling a device-to-device region to a user equipment based on the selected radio resources. For example, the signaling may include broadcasting a configuration message to a plurality of user equipment.

The method can additionally include, at 450, scheduling around the device-to-device region by avoiding scheduling a user equipment near a pair of device-to-device user equipment in the region. In this case, scheduling of non-D2D users around the D2D user can be performed. Consequently, there is no need for non-D2D users to be aware of the D2D region, as such.

The applying the penalty at 420 can include, among other things, modifying a scheduling order, metric, and/or resource assignment for non-device-to-device users around device-to-device transmission. In this approach, the system may not explicitly schedule around D2D transmission. Instead, the system may modify the scheduling metric (for example, a proportional fair metric) so that non-D2D users near D2D communication have a lesser chance of either being scheduled for transmission or being scheduled using the same resources being used for D2D communication.

The method may also include, at 460, using beamforming to steer around the device-to-device region corresponding to a pair of device-to-device user equipment.

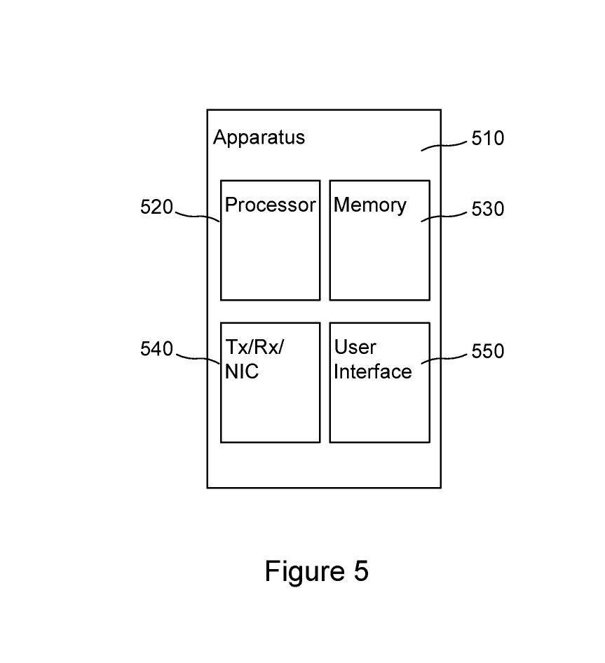

FIG. 5 illustrates an apparatus according to certain embodiments of the present invention. As shown in FIG. 5, an apparatus 510 can be a base station, access point, eNode B, or other device or network element. The apparatus 510 can include at least one processor 520 and at least one memory 530 including computer program instructions.

The at least one processor 520 can be variously embodied by any computational or data processing device, such as a central processing unit (CPU) or application specific integrated circuit (ASIC). The at least one processor 520 can be implemented as one or a plurality of controllers.

The at least one memory 530 can be any suitable storage device, such as a non-transitory computer-readable medium. For example, a hard disk drive (HDD) or random access memory (RAM) can be used in the at least one memory 530. The at least one memory 530 can be on a same chip as the at least one processor 520, or may be separate from the at least one processor 520.

The computer program instructions may be any suitable form of computer program code. For example, the computer program instructions may be a compiled or interpreted computer program.

The at least one memory 530 and computer program instructions can be configured to, with the at least one processor 520, cause a hardware apparatus (for example, apparatus 510) to perform a process, such as the process shown in FIG. 4, or any other process described herein.

The apparatus 510 can also include communications equipment, such as a transmitter (Tx), receiver (Rx), or network interface card (NIC) 540. The Tx/Rx/NIC 540 can be configured to communicate over a wireless connection with one or more user equipment, which may be D2D user equipment, via one more antennas. The Tx/Rx/NIC 540 can also be configured to communicate with a core network, not shown.

The apparatus 510 can also be equipped with a user interface 550. The user interface 550 can be any type of audio or visual (or both) display. Other user interface types are also permitted.

Thus, in certain embodiments, a non-transitory computer-readable medium can be encoded with computer instructions that, when executed in hardware (such as apparatus 510) perform a process, such as one of the processes described above. Alternatively, certain embodiments of the present invention may be performed entirely in hardware.

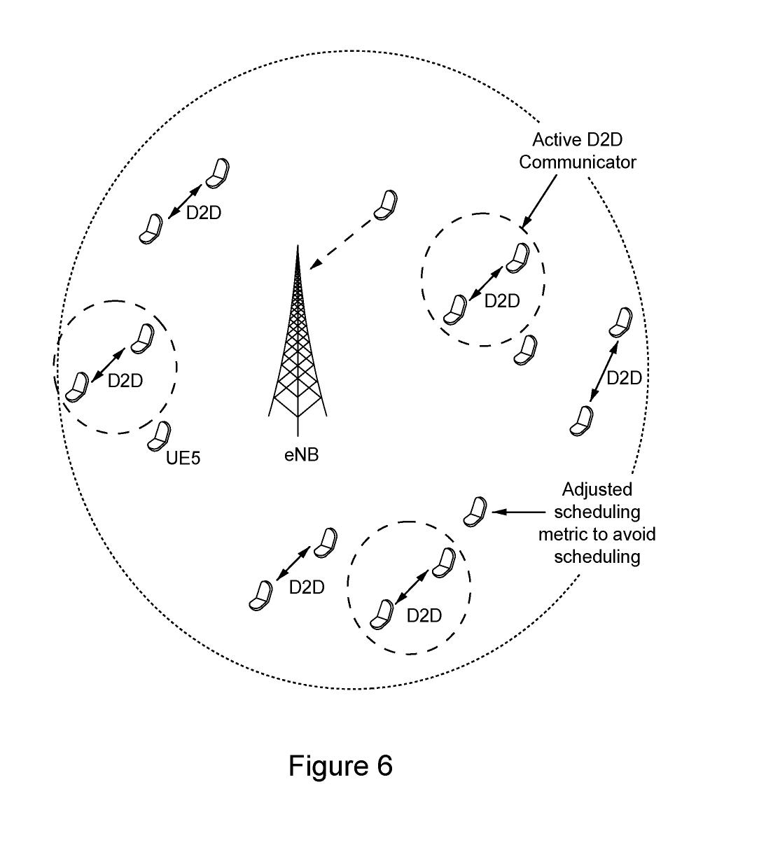

FIG. 6 illustrates interference management according to certain embodiments. Interference management methods can be applied, for example, to a D2D region in the DL. In such a case, the management may include scheduling around D2D pairs. For example, the network can compile a list of D2D pairs. Moreover, the network can identify other UEs in close proximity to the pairs, based on, for example, location information. The eNB can avoid scheduling those nearby UEs during a D2D region. This can be done, for example, by introducing a penalty factor into the scheduling metric of each UE based on expected impact from D2D interference. This penalty factor may be considered only in the D2D region. An example embodiment is

$${P}_{f} ( k ) = \text{?} {I}_{D 2 D}^{γ}$$

$$\text{?} \text{indicates text missing or illegible when filed}$$

where tᵢₙₛₜₐₙₜ is the instantaneous achievable throughput of user k (for example, based on CQI reports), t_{avg} is the average throughput of user k, and I_{D2D} is the expected interference from D2D transmission. The terms α, β, and γ can be fairness-related parameters.

Thus, in certain embodiments an eNB steer UEs away from D2D transmission by adjusting a scheduling metric as shown in FIG. 6. Such steering may help D2D traffic, because nearby UE does not transmit.

As shown in FIG. 6, for example, the crossed out nearby user equipment, such as UE5, may not be scheduled during a D2D region corresponding to the nearby active D2D communication. However, other D2D communication may be permitted during the D2D region, even in the same area, as shown at bottom. Likewise, normal communication from a user equipment that is not close to an active D2D communication may be permitted during the D2D region, as shown at top.

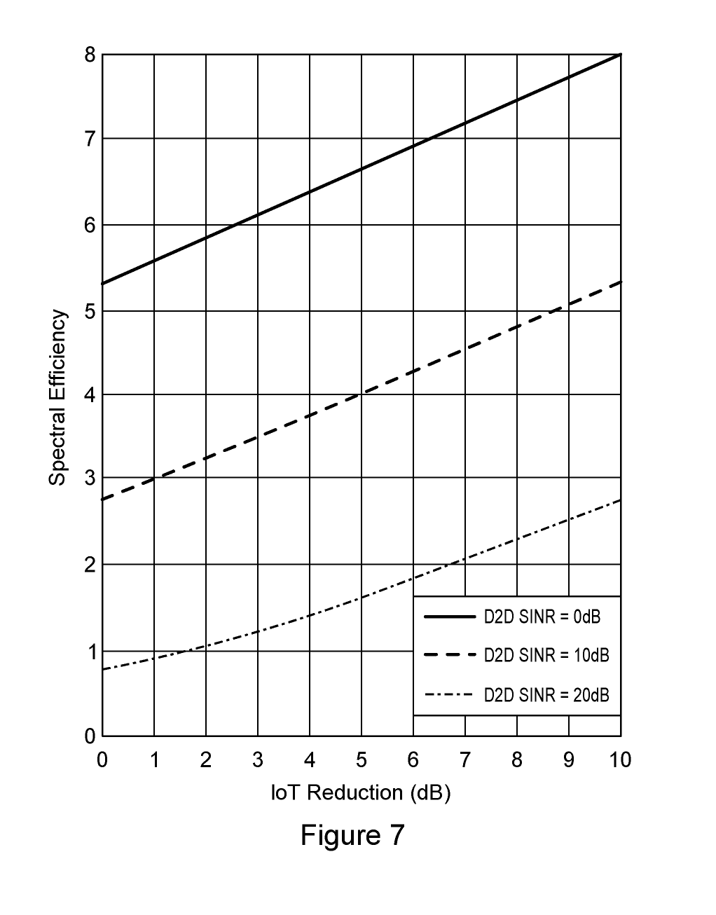

Using such a method, interference to D2D traffic may decrease. The expected performance improvement may depend on the D2D operating point and the amount of reduction. FIG. 7 illustrates gain based on interference over thermal noise (IoT) reduction according to certain embodiments. As shown in FIG. 7, the highest spectral efficiency may be achieved with 20 dB D2D SINR, and the lowest spectral efficiency may be achieved with D2D SINR of 0 dB.

The gain based on IoT reduction is translated into throughput gain in Table 1, below. From table 1, it can be seen that gain in the range of 6%-188% may be possible for an individual D2D pair.

TABLE 1
Throughput gain (%) as a function of IoT reduction.

IoT reduction (dB)

| D2D SINR | 1 | 3 | 5 | 8 |
|---|---|---|---|---|
| Low (0 dB) | 18% | 58% | 106% | 188% |
| Medium (10 dB) | 8% | 26% | 44% | 73% |
| High (20 dB) | 6% | 17% | 26% | 49% |

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

ABS Almost Blank Subframe

CRE Cell Range Extended

D2D Device-to-Device

EPC Enhanced Packet Core

LPS Low power subframe

LTE Long Term Evolution

UE User Equipment

We claim:

1. A method, comprising:
determining a penalty for using a resource for device-to-device communication based on performance metrics; and
applying the penalty in selecting radio resources for a user equipment for device-to-device communication.

2. The method of claim 1, wherein applying the penalty comprises determining whether to use an uplink subframe or a downlink subframe for device to device communication based on a penalty function.

3. The method of claim 1, wherein determining the penalty comprises determining the penalty based on at least one of radio conditions, system loading, priority, served throughput, buffer status, expected interference from device-to-device transmissions, resource block loading, traffic offloading efficiency, or signal to interference plus noise ratio.

4. The method of claim 1, wherein the applying the penalty comprises selecting one of a plurality of alternative resources based on minimizing a penalty function.

5. The method of claim 1, further comprising:
signaling a device-to-device region to a user equipment based on the selected radio resources.

6. The method of claim 5, wherein the signaling comprises broadcasting a configuration message to a plurality of user equipment.

7. The method of claim 1, further comprising:
scheduling around a device-to-device region by avoiding scheduling a user equipment near a pair of device-to-device user equipment in the region.

8. The method of claim 1, wherein the applying the penalty comprises modifying a scheduling order and/or resource assignment for non-device-to-device users around device-to-device transmission.

9. The method of claim 5, further comprising:
using beamforming to steer around the device-to-device region corresponding to a pair of device-to-device user equipment.

10. The method of claim 1, wherein the applying the penalty comprises adjusting either a power of a device-to-device user equipment or a non-device-to-device user equipment based on priority.

11. An apparatus, comprising:
at least one processor; and
at least one memory including computer program code,
wherein the at least one memory and the computer program code are configured to, with the at least one processor, cause the apparatus at least to
determine a penalty for using a resource for device-to-device communication based on performance metrics; and
apply the penalty in selecting radio resources for a user equipment for device-to-device communication.

12. The apparatus of claim 11, wherein the at least one memory and the computer program code are configured to, with the at least one processor, cause the apparatus at least to apply the penalty at least by determining
whether to use an uplink subframe or a downlink subframe for device to device communication based on a penalty function.

13. The apparatus of claim 11, wherein the at least one memory and the computer program code are configured to, with the at least one processor, cause the apparatus at least to determine the penalty at least by determining the penalty based on at least one of radio conditions, system loading, priority, served throughput, buffer status, expected interference from device-to-device transmissions, resource block loading, traffic offloading efficiency, or signal to interference plus noise ratio.

14. The apparatus of claim 11, wherein the at least one memory and the computer program code are configured to, with the at least one processor, cause the apparatus at least to apply the penalty at least by selecting one of a plurality of alternative resources based on minimizing a penalty function.

15. The apparatus of claim 11, wherein the at least one memory and the computer program code are configured to, with the at least one processor, cause the apparatus at least to signal a device-to-device region to a user equipment based on the selected radio resources.

16. The apparatus of claim 15, wherein the at least one memory and the computer program code are configured to, with the at least one processor, cause the apparatus at least to signal at least by broadcasting a configuration message to a plurality of user equipment.

17. The apparatus of claim 11, wherein the at least one memory and the computer program code are configured to, with the at least one processor, cause the apparatus at least to schedule around a device-to-device region by avoiding scheduling a user equipment near a pair of device-to-device user equipment in the region.

18. The apparatus of claim 11, wherein the at least one memory and the computer program code are configured to, with the at least one processor, cause the apparatus at least to apply the penalty by modifying a scheduling order and/or resource assignment for non-device-to-device users around device-to-device transmission.

19. The apparatus of claim 13, wherein the at least one memory and the computer program code are configured to, with the at least one processor, cause the apparatus at least to use beamforming to steer around the device-to-device region corresponding to a pair of device-to-device user equipment.

20. The apparatus of claim 11, wherein the at least one memory and the computer program code are configured to, with the at least one processor, cause the apparatus at least to apply the penalty by adjusting either a power of a device-to-device user equipment or a non-device-to-device user equipment based on priority.

21. A non-transitory computer-readable medium encoded with instructions that, when executed in hardware, perform a process, the process comprising:
determining a penalty for using a resource for device-to-device communication based on performance metrics; and
applying the penalty in selecting radio resources for a user equipment for device-to-device communication.
